(19) United States
(12) Patent Application Publication
(10) Pub. No.: US 2008/0131584 A1
(43) Pub. Date: Jun. 5, 2008

(54) Method for producing porous surfaces on metal components

(76) Inventors: Christoph Laumen, Munich (DE); Anders Salwen, Djursholm (SE); Soren Wiberg, Ekero (SE)

Correspondence Address: THE BOC GROUP, INC., 575 MOUNTAIN AVENUE, MURRAY HILL, NJ, 07974-2064, US

(21) Appl. No.: 11/903,179

(22) Filed: Sep. 20, 2007

(30) Foreign Application Priority Data
Dec. 5, 2006 (EP) 06025128.7

(51) Int. Cl. B05D 5/00; B05D 3/00; B05D 3/04

(52) U.S. Cl. 427/2.24; 427/2.1; 427/331; 427/377

(57) ABSTRACT

The disclosure relates to a method for the modification of the surface structure of a metal body, more preferably for the increase of the surface porosity, wherein a surface of the metal body is initially exposed to an oxidizing atmosphere and subsequently is exposed to a reducing atmosphere.

### CROSS REFERENCE TO RELATED APPLICATIONS

This application claims priority from European Patent Application Serial No. 06025128.7, filed Dec. 5, 2006, the disclosure of which is incorporated herein in its entirety.

### FIELD OF THE DISCLOSURE

The present disclosure relates to a method for modifying the surface structure of a metal body, and in particular, for increasing the surface porosity of the metal body.

### BACKGROUND OF THE DISCLOSURE

Stainless austenitic steels frequently have a smooth metal surface that is without structure after their manufacture and can therefore be frequently wetted only with difficulty. This wetting characteristic has a major influence on the adhesion and durability of paints and coatings, i.e., the application of durable coatings on such surfaces proves difficult.

In medical technology, biocompatible materials such as, for example, titanium are used for producing implants. With such implants, too, a surface that is too smooth also results in problems that are difficult to solve. Among these are, for example, poor contact between the implant and the human tissue in which the implant is implanted.

In the paper “Porous Metal Tubular Support for Solid Oxide Fuel Cell Design”, Electrochemical and Solid-State Letters Volume 9, No. 9, Pages A427 to A429, June 2006, a method for the manufacture of a porous nickel tube is described. To this end, the nickel tube is initially oxidized and subsequently reduced in a hydrogen atmosphere.

The formation of nickel pores at certain temperatures and after certain times is assumed to be due to special relations between the thermal stability of the NiO and the diffusion rates of nickel and oxygen atoms in nickel metal and in NiO.

Contrary to the oxidation of nickel, in Fe or Co containing metals, not only one oxide but more oxides of the type MO, M₂O₃ and M₃O₄, with M=Fe or Co, with different thermal stabilities are formed depending on the oxidation temperature. In addition, in Fe-based or Co-based alloys, oxides formed by alloying elements such as Cr, Mo, Mn, and Si may be formed to make the picture even more complex. During reduction, the diffusion of Fe or Co and of the alloying elements in the matrix and in the oxides creates a complicated picture.

The same principles for Fe- or Co-based alloys also apply for other metal alloys with additions of Cr, Fe, Cu, Co, Mo, Mn and Si, and for Ta- and Ti-based alloys.

### BRIEF SUMMARY OF THE DISCLOSURE

This disclosure provides for a method for the modification of the surface structure of metal body, which comprises a) forming a surface on the metal body having at least one nonmetallic substance in a first method stage; and b) removing from the surface layer at least one of the nonmetallic substances contained in the surface layer in a second method stage. The metal body is a metal alloy comprising at least one of the metals Fe, Cu, Co, Cr, Ti, Ta, Mo, Mn and Si as primary component or as an addition. The at least one nonmetallic substance is C, O, N, S, or P. The modification of the surface structure comprises increasing the surface porosity of the metal.

### DETAILED DESCRIPTION OF SELECTED EMBODIMENTS

An embodiment of the present disclosure is a method to increase the surface porosity of a metal body of a metal alloy comprising at least one of the metals Fe, Cu, Co, Cr, Ti, Ta, Mo, Mn and Si.

In an embodiment, this disclosure provides a method for modifying the surface structure of a metal body, which is characterized in that the metal body is a metal alloy comprising at least one of the metals Fe, Cu, Co, Cr, Ti, Ta, Mo, Mn and Si as primary component or as addition, and wherein in a first method stage on a surface of the metal body a surface layer is created which contains at least one nonmetallic substance, and subsequently in a second method stage at least one of the nonmetallic substances contained in the surface layer is at least in part removed from the surface layer. In an embodiment, this disclosure increases the surface porosity of the surface structure. In an embodiment, the at least one nonmetallic substance is C, O, N, S or P.

In an embodiment, the disclosure is the two-stage nature of the method. In a first method stage a surface layer is created on the metal body which has at least one nonmetallic element or a compound containing one nonmetallic element. In an embodiment, in the first method stage, carbon, oxygen, nitrogen, sulfur or phosphorus are installed in the surface layer as nonmetallic elements. The creation of this surface layer need not take place in one step, but can also be carried out in several steps.

After this, a nonmetallic element or a compound containing these nonmetallic elements can be removed again partly or wholly from the surface layer in a second method stage. In this way, vacancies remain in the surface layer which results in a porous surface. This second method stage of the removal of the nonmetallic elements from the surface layer can also take place in one or several steps.

According to an embodiment of the present disclosure, there is no need for a final treatment of the surface after the above mentioned second method stage. In particular, the surface layer is not subjected to an etching process or a similar process.

In an embodiment, the first method stage and/or the second method stage consist of several method steps, wherein in each method step at least one nonmetallic substance is deposited in the surface layer and/or removed from the surface layer. The metal body can, for example, be initially modified in a treatment atmosphere so that a nonmetallic element is installed in the surface of the body, for example, the metal surface is oxidized through controlled reaction with an atmosphere containing oxygen. After this, the metal body is again subjected to the same treatment in order to bring about an additional installation of the nonmetallic element in the surface structure of the metal body, i.e., in the mentioned example, the metal surface would be exposed to an additional oxidation reaction.

The same applies to the second method stage: the removal of the nonmetallic components from the surface layer can likewise take place in several steps. Dividing the two method stages of the installation or the removal of the nonmetallic components into several steps is likely to be more practical when a larger amount of these nonmetallic substances is to be installed in or removed from this surface, but prolonged or more intensive treatment of the metal body has disadvantageous effects on the metal properties. Through the mentioned division of a method stage into several steps performed in succession a more careful treatment of the metal body is achieved.

The division of a method stage into several steps is also advantageous if a plurality of different substances is to be installed in or removed from the surface structure of the metal body. To this end, the reaction conditions are optimized in a first step such that, in an embodiment, a certain nonmetallic substance reacts with the surface of the metal body. In a second step, the reaction conditions are modified so that another substance is integrated in the surface layer. Additional steps for the controlled modification of the surface can follow. Of course, this does not only apply to the installation of the nonmetallic elements in the surface but also to their removal in a second method stage.

In an embodiment of the present disclosure, the two-stage process, i.e., the sequence of the first and the second method stage, the process is carried out repeatedly. This means that a porous surface layer is initially created through the deposition and at least a part of the mentioned substances is removed again. The surface of the metal body pretreated in this way may be subjected one more time to the method according to the disclosure under changed method conditions. As a result, a surface with different size pores can be produced. For example, a coarsely structured surface, which nas inner surfaces with a fine structure, can be created through the appropriate choice of the method parameters. Such surfaces with coarse and fine porosities are, for example, of advantage for the manufacture of heat exchanger surfaces or catalytic converter surfaces.

The deposition of the nonmetallic elements or compounds containing these and/or their removal from the surface layer may be carried out through treatment of the metal body in a heat treatment atmosphere. By suitably selecting the composition of the heat treatment atmosphere and corresponding selection of the process parameters such as, for example, pressure and temperature, it is possible in this way to bring about reactions between the components of the heat treatment atmosphere and the surface of the metal body in a controlled manner and to produce a defined surface layer.

According to an embodiment, the metal surface is initially oxidized and subsequently reduced. During the oxidation step an oxide layer forms on the metal surface in the known manner. In a second step the oxidized metal surface is now exposed to a reducing atmosphere. During this treatment at least a part of the existing oxides is removed through reduction, wherein corresponding pores remain in the surface.

By carrying out oxidation followed by reduction of the metal surface a porous surface structure that can be easily wetted is created.

The type and shape of the surface porosity created depends on the method parameters during the first method stage and during the second method stage. In order to obtain a pore structure which is optimally adapted to the set requirements the parameters, such as temperature and duration, have to be suitably selected in both the method stages.

These parameters depend on the type of metal or alloy whose surface is to be modified, on the substance that is to be installed in or removed from this surface layer, on the type of the oxidizing and/or reduction agent employed and on the desired pore structure, for example, their size. If the surface modification through heat treatment of the metal body according to the present disclosure is performed in a gas atmosphere, the temperature of the atmosphere and the respective exposure times are therefore adjusted to the surface to be treated as a function of the type of the metal or the alloy, as a function of the type of the oxidation and reduction agent employed and/or as a function of the desired pore structure.

It has been shown that during the treatment of steels the first method stage may be carried out at a temperature between 800° C. and 1300° C. In some embodiments, the temperature may be between 1000° C. and 1200° C. For the duration of the heat treatment, the time span may be between 10 and 200 minutes. In some embodiments, the time span may be between 30 and 120 minutes. For titanium, Cr—Co or other materials the mentioned parameters can serve as a first point of reference but further optimization is practical as a rule.

The second method stage, for example, a reduction step, may be carried out at temperatures between 900° C. and 1400° C. for the duration of 5 minutes to 120 minutes. In some embodiments, the duration is between 60 and 120 minutes.

To create an oxide layer in the first method stage, the surface may be exposed to an atmosphere with an oxygen component of 1 to 100%. In an embodiment, air is used as an oxidizing agent. Depending on the metal to be oxidized and the desired shape of the pore structure, however, it may also be favorable to carry out the oxidation with the help of air enriched with oxygen or technically pure oxygen as oxidizing agent. In an embodiment, an atmosphere with an oxygen content of at least 50% is used. In another embodiment, an atmosphere with an oxygen content of at least 90% of oxygen is used. If applicable, the temperature of the oxidation treatment has to be suitably adjusted in this case. It has also been shown also shown that other oxidizing agents such as, for example, moist air, steam, carbon dioxide or mixtures of nitrogen and oxygen are suitable to bring about the oxidation according to the disclosure.

In an embodiment of the disclosure, the oxidation of the surface can likewise develop or be created as a side effect during another heat treatment or transformation step. During hot rolling, for instance, the surface of the metal is already oxidized so that additional separate oxidation need not necessarily be performed.

The reduction of the oxide layer may be carried out in a hydrogen atmosphere. In an embodiment, it has proved itself to employ a reducing atmosphere with hydrogen content of at least 75%. In another embodiment, the reaction of the oxide layer is carried out in a hydrogen content of at least 90%. In still another embodiment, the hydrogen content is at least 98% of hydrogen. Instead or in addition to hydrogen, an atmosphere containing CO can also be used for reduction.

It has been shown that with the treatment of Co—Cr alloys with a relatively high carbon content according to the present disclosure a part of the carbon atoms present in the alloy is utilized in the second method stage for the reduction of the nonmetallic substances. The observed characteristic of carbon as reduction agent can, for example, be deliberately employed in that carbon is added to the hydrogen or CO atmosphere used in the second method stage.

In an embodiment of the present disclosure, the oxidation is carried out in air and the subsequent reduction in an atmosphere of pure hydrogen.

In an embodiment according to the present disclosure is a method create a porous metal surface. To this end, non-metals are initially deposited in the surface of the metal body during the first method stage, for example, an oxidation step, and, during the second method stage, for example, during a reduction step, are removed again so that the desired pores remain. Both these method stages are advantageously carried out in immediate succession. In an embodiment, the surface is not exposed to any other heat treatment process between the two method stages. In another embodiment, more preferably between an oxidation and a reduction step.

The method is used to advantage in order to treat the surface of a body of stainless austenitic steel, a Co—Cr alloy, a nickel alloy, titanium, tantalum or an alloy containing these substances according to the present disclosure. Here, either the entire body or only the surface of the body to be treated is successively exposed to the two method stages, i.e., for example, initially to an oxidizing and subsequently to a reducing atmosphere.

In an embodiment, the disclosure herein is utilized for modifying the surface structure of devices for medical or pharmaceutical purposes. For example, medical implants e.g. tooth implants, stents, doctor's instruments, catheters, prostheses or artificial joints or materials of which such implants and prostheses are manufactured, are modified according to the present disclosure.

The surface porosity improves the contact between the implant and the human or animal tissues or bones. On the other hand, not only the implants or prostheses, but also the doctor's instruments, are frequently provided with coatings, for example, an hydroxyapatite coating. Through the use of the method according to the present disclosure clearly improved adhesion of such layers is achieved.

The pores formed from the present disclosure are not limited only in the area of medical technology and surgery, but also in other technical areas. They may be utilized in order to deposit active substances, isotopes, radioactive substances for combating cancer or pharmaceuticals in the pores which are to be given off to the environment or introduced in the surrounding tissue.

In an embodiment, another area of application of the method according to the present disclosure is the treatment of metal surfaces in order to improve their adhesion characteristics for subsequent painting or coating.

In an embodiment, another area of application of the present disclosure is the modification of the surface structure of heat exchangers in order to improve the heat transfer and the flow conditions along the heat exchanger surfaces. The modified surfaces according to the present disclosure can also bring advantages in catalytic converters and batteries.

It has also been shown that the optical properties of surfaces, for example, the absorption capacity, can be influenced in a controlled manner through the present disclosure. A potential area of application for this are solar collectors.

At present, surfaces requiring a defined structure or porosity are frequently produced through powder coating or sintering-on of powder. The present disclosure constitutes a cost-effective possibility of superseding these relatively expensive methods.

Finally, it is also possible with thin metal bodies to not only modify their surface but to produce a body according to the present disclosure which is porous throughout. Such porous metal bodies for example can be employed as filters.

It has been shown that during the two method stages of the creation or the removal of the nonmetallic components increased diffusion of alloying elements into the metal surface occurs. In an embodiment, the method according to the present disclosure is utilized to alloy the metal surface in a controlled manner. In an embodiment, a few micrometer thick surface layer is created on the metal body in this manner, in which the Cr or Mo-content compared with the remainder of the surface layer is increased. It was, for example, discovered that the Cr-content in this outermost layer can be increased by 5 to 15%.

This controlled enrichment of elements in the outermost surface layer may have greater advantages in applications where the corrosion resistance of the surface is important, for example, in order to protect medical implants from acids produced by the body.

In an embodiment, an area of application of the present disclosure is the increase of the surface hardness. In an embodiment, an area of application of the present disclosure is the increase in surface hardness of micromechanical or electronic components. With the suitable selection of the process parameters a surface layer with particularly small grain size is formed. This is attributed to the fact that the metal atoms which remain after the removal of the nonmetallic atoms in the second method stage con pose themselves into new grains. If, in the process, very many new small grains per unit area are formed, this results in a high surface hardness.

The present disclosure has numerous advantages compared with the prior art. With the method according to the present disclosure, the surface porosity can be customized. Depth and size of the pores can be set through suitable selection of the method parameters in the oxidation and in the reduction steps. In an embodiment, stainless austenitic steels, Co—Cr-alloys, titanium and tantalum materials, which frequently have a smooth surface structure, can be prepared according to the present disclosure so that subsequent coatings last better and durably.

It will be understood that embodiment(s) described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

### EXAMPLE 1

A steel of Type AISI316 was oxidized in an oxygen atmosphere at 1200° C. for 30 minutes and subsequently reduced in a 100% hydrogen atmosphere at 1150° C. likewise for 30 minutes. This produced pores with a size between 1 micrometer and 10 micrometers and the pore channels that formed reached a depth of several micrometers.

### EXAMPLE 2

A hot-rolled wire whose surface oxidized during hot rolling and which was subsequently reduced in a hydrogen atmosphere at 1170° C. The porosity of the surface is clearly visible.

### EXAMPLE 3

The surface porosity of tooth implants of titanium was modified according to the present disclosure. It was discovered that the surface topography of the tooth implants has a substantial influence on the process and the speed of biological processes following the implantation in the human or animal body. This applies to processes in the nanometer range up to processes at the macro-level or with macro-particles.

What is claimed is:

1. A method for the modification of the surface structure of a metal body, which comprises a) forming a surface on the metal body having at least one nonmetallic substance in a first method stage; and b) removing from the surface layer at least one of the nonmetallic substances contained in the surface layer in a second method stage.

2. The method according to claim 1 wherein the metal body is a metal alloy comprising at least one of the metals Fe, Cu, Co, Cr, Ti, Ta, Mo, Mn and Si as primary component or as addition.

3. The method according to claim 1 wherein the at least one nonmetallic substance is C, O, N, S, or P.

4. The method according to claim 1 wherein the modification of the surface structure comprises increasing the surface porosity of the metal.

5. The method according to claim 1 wherein the first method stage and/or the second method stage consists of several method steps.

6. The method according to claim 5 wherein each method step comprises at least one nonmetallic substance that is deposited in the surface layer and/or removed from the surface layer.

7. The method according to claim 1 wherein the sequence of the first and the second method stage are carried out repeatedly.

8. The method according to claim 1 wherein the metal body in the first and/or second method stage is exposed to a heat treatment in a defined gas atmosphere.

9. The method according to claim 8 wherein the surface of the metal body in the first method stage is exposed to an oxidizing atmosphere and in the second method stage to a reducing atmosphere.

10. The method according to claim 9 wherein the metal body in the first method stage is oxidized in an atmosphere containing oxygen, water and/or carbon dioxide as oxidizing agent.

11. The method according to claim 10 wherein the oxidizing atmosphere has an oxygen content of at least 50%.

12. The method according to claim 11 wherein the oxiding atmosphere has an oxygen content of at least 75%.

13. The method according to claim 11 wherein the oxiding atmosphere has an oxygen content of at least 90%.

14. The method according to claim 1 wherein the metal body in the second method stage is modified in an atmosphere containing hydrogen and/or carbon monoxide as reduction agent.

15. The method according to claim 14 wherein the reducing atmosphere has a hydrogen content of at least 75%.

16. The method according to claim 15 wherein the reducing atmosphere has a hydrogen content of at least 90%.

17. The method according to claim 15 wherein the reducing atmosphere has a hydrogen content of at least 99%.

18. The method according to claim 1 wherein the surface in the first method stage is treated for a period of time between 10 and 200 minutes.

19. The method according to claim 1 wherein the surface in the first method stage is treated for a period of time between 30 and 120 minutes.

20. The method according to claim 1 wherein the surface layer in the first method stage is created at a temperature between 800° C. and 1300° C.

21. The method according to claim 20 wherein the surface layer in the first method stage is created at a temperature between 1000° C. and 1200° C.

22. The method according to claim 1 wherein the nonmetallic substances in the second method stage are removed again at least in part at a temperature between 900° C. and 1400° C.

23. The method according to claim 22 wherein the nonmetallic substances in the second method stage are removed again at least in part at a temperature between 1200° C. and 1300° C.

24. The method according to claim 1 which comprises modifying the surface of a body of stainless austenitic steel, a Co—Cr-alloy, titanium, tantalum or an alloy containing these substances.

25. The method according to claim 1 which comprises modifying the surface structure of devices for medical or pharmaceutical purposes.

26. The method according to claim 25 wherein the devices are implants.

27. The method according to claim 1 which comprises increasing the porosity of the surface and depositing an active substance in the pores.

28. The method according to claim 27 wherein the active substance is active in a medical or pharmaceutical manner.

29. The method according to claim 1 wherein the metal alloy is a steel alloyed with chromium or a stainless steel.
